(19) United States
(12) Patent Application Publication
(10) Pub. No.: US 2019/0286391 A1
(43) Pub. Date: Sep. 19, 2019

(54) INFORMATION PROCESSING TERMINAL, METHOD OF CONTROLLING THE SAME, STORAGE MEDIUM, AND IMAGE FORMING APPARATUS

(71) Applicant: CANON KABUSHIKI KAISHA, Tokyo (JP)

(72) Inventors: Satoshi Totsuka, Tsukuba-shi (JP); Aya Kasahara, Tokyo (JP); Masaki Kashiwagi, Hiratsuka-shi (JP); Junichi Mori, Toride-shi (JP)

(21) Appl. No.: 16/352,266

(22) Filed: Mar. 13, 2019

(30) Foreign Application Priority Data
Mar. 19, 2018 (JP) 2018-051522

(51) Int. Cl. G06F 3/12

(52) U.S. Cl. CPC G06F 3/1232; G06F 3/1286; G06F 3/1207

(57) ABSTRACT

An information processing terminal accepts a print job inputted into the image forming apparatus via the user operation and obtains capability information of the image forming apparatus. The information processing terminal obtains the total number of print sheets for when the accepted print job will be processed and the maximum number of print sheets that the image forming apparatus can process without requiring user action, which is included in the obtained capability information. Furthermore, the information processing terminal, in the case where the total number of print sheets exceeds the maximum number of print sheets, outputs a warning message including that user action will be necessary.

### BACKGROUND OF THE INVENTION

### Field of the Invention

The present invention relates to an information processing terminal, a method of controlling the same, a storage medium, and an image forming apparatus.

### Description of the Related Art

There is a “print reservation” in which, when a print reservation job for which a print start time is designated to an image forming apparatus from a printer driver installed on an information processing terminal or the like is inputted, the image forming apparatus starts the printing at the designated time. The purpose of a “print reservation” is to perform printing so not to impede another user by designating a print start time to be the middle of the night or during a lunch break when a user desires mass printing.

Meanwhile, in a case where a print reservation job is executed at a time when a user is absent, such as in the middle of the night, it is not possible to complete the job in the case where a user action is necessary during the job. For example, when a print job exceeds a maximum number of contained sheets that can be stored in the paper feed tray of the image forming apparatus or a maximum number of stacked sheets of a discharge tray, if the printing stops part way through and the sheets that are stacked on the tray are not removed by a user, it will not be possible for the subsequent processing to be continued, and printing will not be completed.

Japanese Patent Laid-Open No. H11-203089 proposes a technique in which, when a print job is sent from a printer driver, if a processing load (for example, the number of print sheets) is greater than or equal to a threshold set in advance, a warning message for confirming whether or not data to be printed is correct is displayed to the user. With this, unnecessary printing is prevented.

However, there is a problem as is recited below in the foregoing conventional technique. For example, in the foregoing conventional technique, since the maximum number of contained sheets that can be stored in the paper feed tray and the maximum number of stacked sheets of the discharge tray differ depending on the image forming apparatus, it is not possible to determine whether or not printing will stop during job processing by a determination according to a threshold that is set in advance. In other words, in the foregoing conventional technique, the objective is to prevent unnecessary printing, and the threshold is set from the perspective of the administrator or user without consideration of the processing capability of the apparatus. Thus, even in a case where a warning message is given, there are cases in which printing does not stop during processing of the job, and even in a case where a warning message is not given, there are cases in which printing does stop during the processing of the job.

### SUMMARY OF THE INVENTION

The present invention enables realization of a mechanism for determining whether or not printing will stop during processing of a job based on the processing capabilities of an image forming apparatus, and warning the user who inputted the job thereof.

One aspect of the present invention provides an information processing terminal operable to input a print job into an image forming apparatus, the terminal comprising: an acceptance unit that accepts a print job to be inputted into the image forming apparatus via a user operation; a memory device that stores a set of instructions; and at least one processor that executes the set of instructions to: obtain capability information of the image forming apparatus, and in a case where a total number of print sheets for when the accepted print job will be processed exceeds a maximum number of print sheets that can be processed without the image forming apparatus requiring user action, output a warning message that includes that user action will be required, wherein the maximum number of print sheets is included in the obtained capability information.

Another aspect of the present invention provides a method for controlling an information processing terminal operable to input a print job into an image forming apparatus, the method comprising: accepting a print job to be inputted into the image forming apparatus via a user operation; obtaining capability information of the image forming apparatus; and in a case where a total number of print sheets for when the accepted print job will be processed exceeds a maximum number of print sheets that can be processed without the image forming apparatus requiring user action, outputting a warning message that includes that user action will be required wherein the maximum number of print sheets is included in the obtained capability information.

Still another aspect of the present invention provides a non-transitory computer-readable storage medium storing a computer program for causing a computer to execute each step in a method for controlling an information processing apparatus operable to input a print job into an image forming apparatus, the method comprising: accepting a print job to be inputted into the image forming apparatus via a user operation; obtaining capability information of the image forming apparatus; and in a case where a total number of print sheets for when the accepted print job will be processed exceeds a maximum number of print sheets that can be processed without the image forming apparatus requiring user action, outputting a warning message that includes that user action will be required wherein the maximum number of print sheets is included in the obtained capability information.

Yet still another aspect of the present invention provides an image forming apparatus, comprising: an acceptance unit that accepts a print job via a user operation; a memory device that stores a set of instructions; and at least one processor that executes the set of instructions to: in a case where a total number of print sheets for when the print job accepted by the acceptance unit will be processed exceeds a maximum number of print sheets that the image forming apparatus can process without requiring user action, output a warning message that includes that user action will be required.

Further features of the present invention will be apparent from the following description of exemplary embodiments with reference to the attached drawings.

### BRIEF DESCRIPTION OF THE DRAWINGS

FIG. 1 is a view for illustrating a system configuration according to an embodiment.

FIG. 2 is a block diagram of an information processing terminal according to an embodiment.

FIG. 3 is a block diagram of an image forming apparatus according to an embodiment.

FIG. 4 is a view for illustrating a software configuration of a control program of an information processing terminal according to an embodiment.

FIG. 5 is a flowchart for illustrating processing for generating print data of the information processing terminal according to an embodiment.

FIG. 6 is a flowchart for illustrating processing for counting logical pages of the information processing terminal according to an embodiment.

FIG. 7 is a flowchart for illustrating processing for counting the total number of print sheets of the information processing terminal according to an embodiment.

FIG. 8 is a flowchart for illustrating processing for obtaining capability information of the information processing terminal according to an embodiment.

FIG. 9A to FIG. 9C are views for illustrating examples of print instruction screens of a printer driver according to an embodiment.

FIG. 10A to FIG. 10C are views for illustrating examples of warning screens that a printer driver displays according to an embodiment.

FIG. 11 is a view for illustrating an example of capability information that a printer driver obtains according to an embodiment.

FIG. 12 is a view for illustrating an example of print reservation job information that a printer driver obtains according to an embodiment.

FIG. 13 is a flowchart illustrating processing for counting the total number of print sheets considering a received print reservation job according to an embodiment.

### DESCRIPTION OF THE EMBODIMENTS

Preferred embodiments of the present invention will now be described in detail with reference to the drawings. It should be noted that the relative arrangement of the components, the numerical expressions and numerical values set forth in these embodiments do not limit the scope of the present invention unless it is specifically stated otherwise.

### First Embodiment

Below, description will be given for a first embodiment of the present invention. In the present embodiment, description will be given for a control method in an information processing terminal for when transmitting, from the information processing terminal to an image forming apparatus, a print job (hereinafter, referred to as a print reservation job) for which a print start time (hereinafter, referred to as a reservation time) is designated. Note that, the present invention is not intended to be limited to the configurations described below, and, for example, configuration may be taken to perform some of the processing that is performed in the information processing terminal in the image forming apparatus. For example, in a case where a user inputs a print job via a user interface provided in the image forming apparatus, all of the processes that are described below end up being performed on the image forming apparatus.

<System Configuration>

First, with reference to FIG. 1, an example of a configuration of a system according to the present embodiment is described. As illustrated in FIG. 1, in the present system, an information processing terminal 101 and an image forming apparatus 111 are connected so as to be able to communicate with each other via a LAN 105. Note that, regarding a communication connection, wired connection and wireless connection configurations are possible. Also, a plurality of each apparatus may be connected to the present system. The information processing terminal 101 is a personal computer, a notebook PC, a tablet PC, a smart phone or the like on which an image forming apparatus printer driver and application are installed. The image forming apparatus 111 is a printer that can print print jobs received from the information processing terminal 101.

<Configuration of Information Processing Terminal>

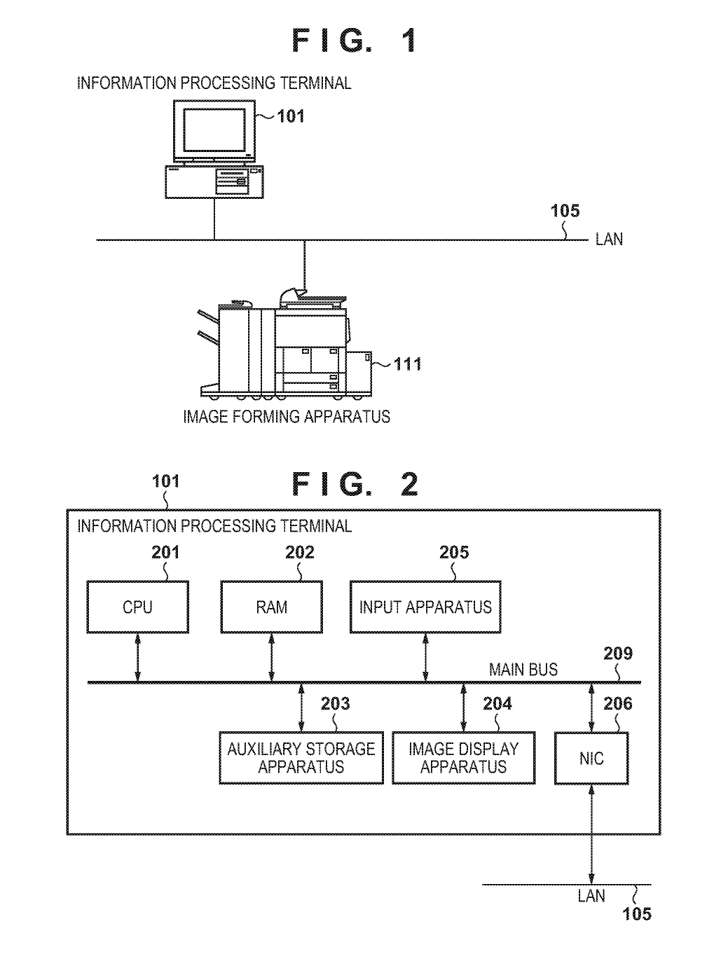

Next, with reference to FIG. 2, an example of the internal configuration of the information processing terminal 101 according to the present embodiment will be described. The information processing terminal 101 comprises a CPU 201, a RAM 202, an auxiliary storage apparatus 203, an image display apparatus 204, an input apparatus 205, and an NIC (Network Interface Card) 206. The respective components can transmit and receive information to each other via a main bus 209.

The CPU 201 is a central processing unit that executes information processing when controlling characteristic processing of the present invention. The RAM 202 is a memory for providing a work area of the CPU 201. The auxiliary storage apparatus 203 is a storage apparatus (a hard disk, a floppy disk, a CD-ROM, or the like) that provides a control program in the present embodiment.

The image display apparatus 204 is a display unit (specifically, a CRT display, a liquid crystal display, or the like) that is used for notifying the user of a message. The input apparatus 205 is a user interface that accepts user operations and inputs commands (specifically, a mouse, a keyboard, or the like). The NIC 206 is a network interface card (NIC) for transmitting and receiving data with respect to another network device via the LAN 105.

<Configuration of Image Forming Apparatus>

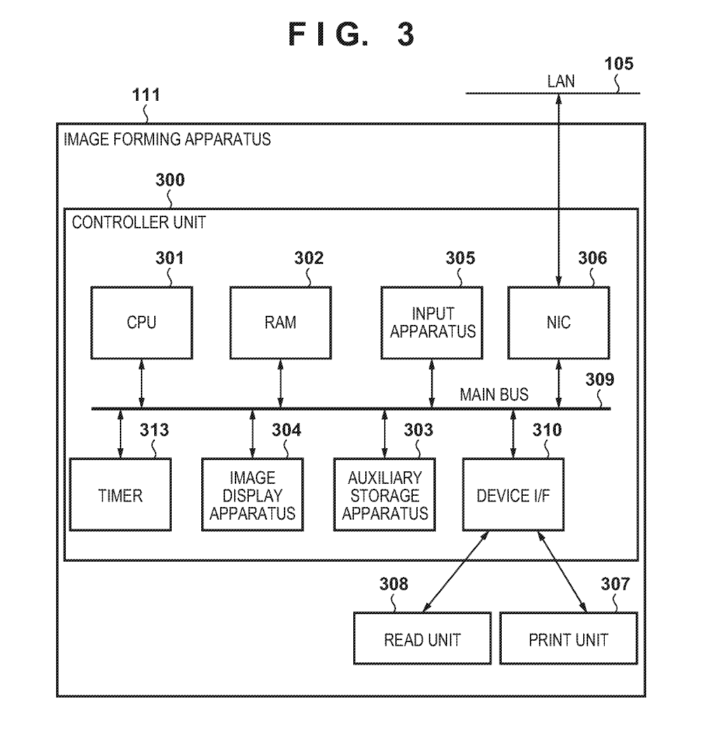

Next, with reference to FIG. 3, an example of the internal configuration of the image forming apparatus 111 according to the present embodiment will be described. The image forming apparatus 111 comprises a controller unit 300 for comprehensively controlling the apparatus, a read unit 308 for reading an image from an original, and a print unit 307 for printing an image onto a sheet. Also, the controller unit 300 comprises a CPU 301, a RAM 302, an auxiliary storage apparatus 303, an image display apparatus 304, an input apparatus 305, an NIC 306, a device I/F 310, and a timer 313. The respective components can transmit and receive information to each other via a main bus 309.

The CPU 301 is a central processing unit that executes information processing when controlling the image forming apparatus 111. The RAM 302 is a memory for providing a work area for the CPU 301 and for temporarily storing data. The auxiliary storage apparatus 303 is a storage apparatus used for temporarily storing data and is used in place of the RAM 302 (a hard disk, a CD-ROM, or the like).

The image display apparatus 304 is a display unit such as a touch panel, and displays the status of an image forming apparatus, error messages, and the like. The input apparatus 305 is a user interface of a touch panel for a user to input commands, and is used by the user for operations such as designation of a desired print job. The NIC 306 is a network interface card for transmitting and receiving data bidirectionally with respect to another network device via the LAN 105.

The print unit 307 prints image data read by the read unit 308 or image data received from an external apparatus onto a sheet. The read unit 308 is a scanner for scanning a paper original placed on an original platen and generating black and white binary or color multi-valued image data. The read image data can be printed by the print unit 307 as is, or stored in the auxiliary storage apparatus 303 and then printed at a particular timing.

The device I/F 310 is connected to the read unit 308 and the print unit 307, and controls data transmission/reception with respect to each of these units. The timer 313 is a timer for performing timing management, and is used for a timing determination when printing a print reservation job at a print start time, for example.

<Software Configuration of Information Processing Apparatus>

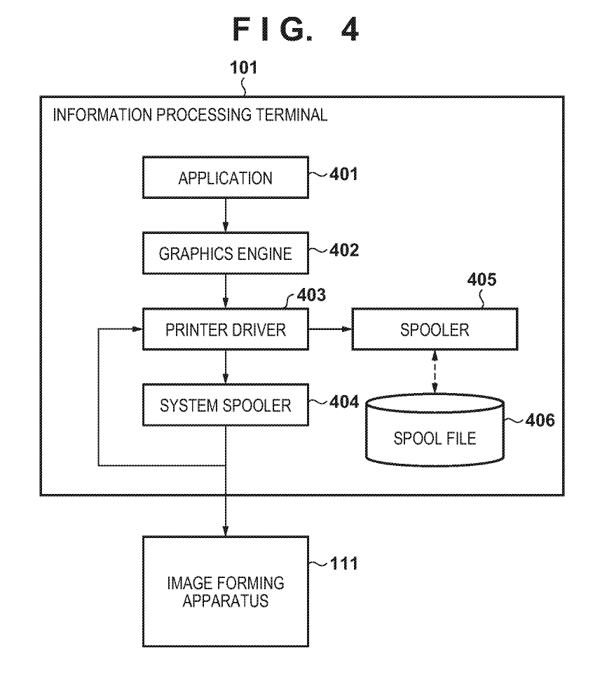

Next, with reference to FIG. 4, an example of a software configuration for print processing in the information processing terminal 101 will be described. The information processing terminal 101, as a software configuration, comprises an application 401, a graphics engine 402, a printer driver 403, a system spooler 404, a spooler 405, and a spool file 406. These software configurations exist as files stored in the auxiliary storage apparatus 203, for example. These program modules, when executed, are loaded into the RAM 202 and executed by an OS or a module that uses the respective module. Also, the application 401 and the printer driver 403 may be added to the auxiliary storage apparatus 203 via a CD-ROM (not shown) or a network (not shown). The application 401 that is stored in the auxiliary storage apparatus 203 is loaded into the RAM 202 and executed by the CPU 201.

When performing printing from the application 401 in relation to the image forming apparatus 111, rendering data is outputted by using a graphics engine 402 that similarly can be loaded into the RAM 202 and executed. Here, description is given using the Windows (registered trademark) OS of Microsoft Corporation USA. On Windows (registered trademark), a graphics engine 402 of the OS is typically referred to as a GDI (Graphics Device Interface). The application 401 outputs rendering data referred to as a GDI function to the GDI which is the graphics engine.

The graphics engine 402 similarly loads a printer driver 403 that is prepared for each image forming apparatus into the RAM 202 from the auxiliary storage apparatus 203. After that, the graphics engine 402 converts the output of the GDI function from the application 401 into a DDI (Device Driver Interface) function based on a library, and outputs the DDI function to the printer driver 403. Next, the printer driver 403, based on the DDI function accepted from the graphics engine 402, converts a control command that the printer can recognize into, for example, PDL (Page Description Language). The printer control command resulting from the conversion is outputted as print data to the image forming apparatus 111 through the LAN 105 via the system spooler 404 which is loaded into the RAM 202 by the OS.

Additionally, in the system of the present embodiment, there is a configuration for spooling print data from the application 401 in temporarily intermediate code data. In a case of temporarily spooling, the printer driver 403 converts PDL into intermediate code in units of pages and sends the intermediate code to the spooler 405, and the spooler 405 stores the intermediate code as a spool file 406. By storing intermediate data in units of pages in the spool file 406, it becomes possible to count the number of logical pages of the print job, and to calculate the total number of print sheets in accordance with print settings.

This intermediate code spool file stored in units of pages is referred to as a page description file (PDF). Also, the spooler 405 obtains print settings (print reservation, paper feed unit, discharge destination, N-up, double-sided) related to print data set in relation to the printer driver 403 from the printer driver 403, and stores the settings in the spool file 406 as a file for each job. A setting file stored for each job is referred to as a job setting file (simplified to SDF: Spool Description File). Regarding print settings for print data, an operator makes settings of the printer driver 403 in advance, prior to a print instruction from an application.

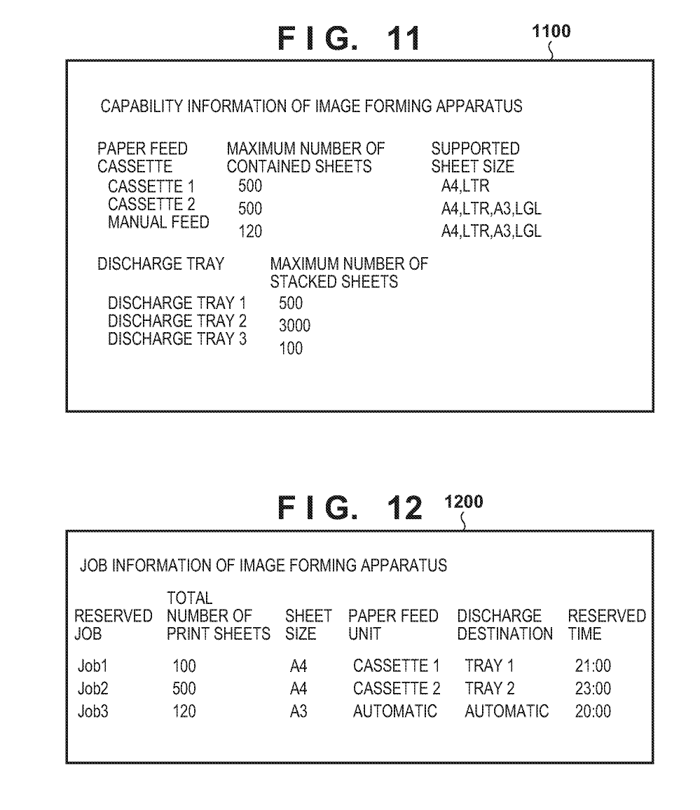

Also, the printer driver 403 functions as a capability acquisition unit, and transmits a request to obtain capability information of the image forming apparatus 111 to the image forming apparatus 111 via the LAN 105. The image forming apparatus 111, in response to the request to obtain the capability information from the printer driver 403, transmits to the printer driver 403 information related to a maximum number of print sheets that can be processed as the capability information. Here, the maximum number of print sheets includes information of a maximum number of contained sheets of a paper feed tray (paper feed cassette) and a maximum number of stacked sheets of a discharge tray, and is a maximum value of the number of sheets that can be printed continuously without a user replenishing the paper feed tray with sheets or removing sheets that have been printed and are stacked on a discharge tray. FIG. 11 illustrates an example of capability information of an image forming apparatus 111 that the printer driver 403 receives. In the capability information, information of a maximum number of contained sheets and a sheet size that can be contained corresponding to each paper feed tray and a maximum number of stacked sheets corresponding to each discharge tray are included. As illustrated in FIG. 11, in a case where the image forming apparatus 111 comprises a plurality of paper feed cassettes and a plurality of discharge trays, information of the possible numbers of sheets and sheet sizes is included.

### Screen Examples

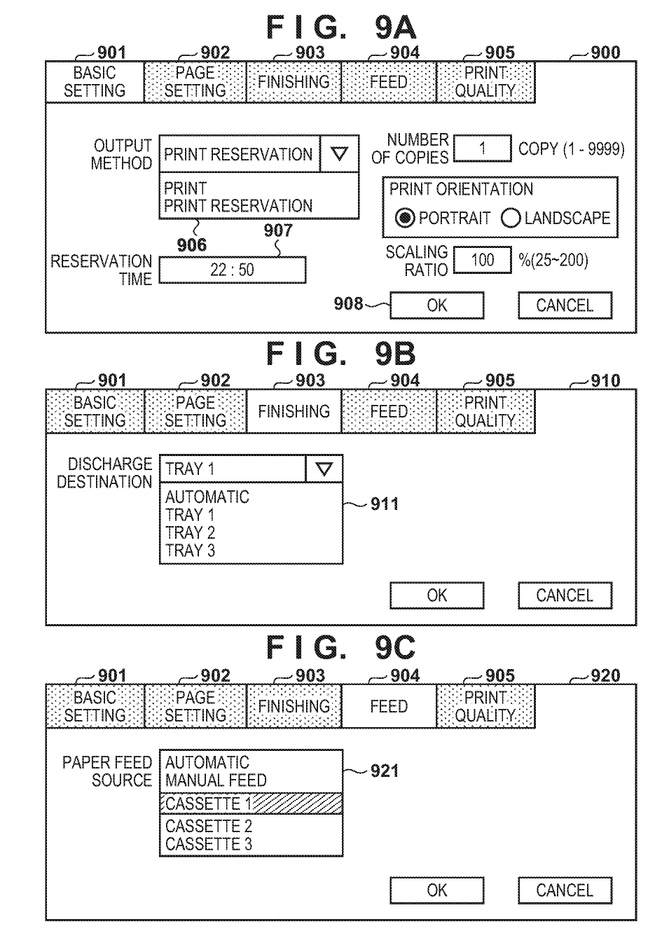

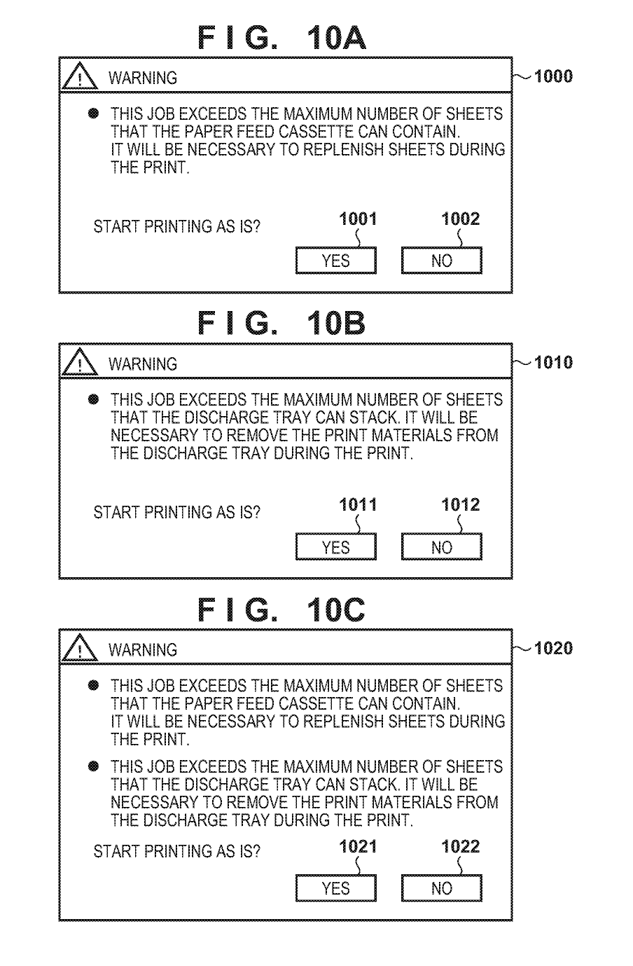

Next, with reference to FIG. 9A to FIG. 10C, description is given of examples of screens displayed on the image display apparatus 204 of the information processing terminal 101.

FIG. 9A is an example of a designation screen 900 that the printer driver 403 displays on the image display apparatus 204 for a user to designate print settings. Reference numeral 906 is an output method for designating a method by which the image forming apparatus 111 is to process a print job. In the present embodiment, configuration is such that the user can select “print” or “print reservation” as the output method 906. The user, in the case where print reservation is selected by the output method 906, becomes able to designate a reservation time 907. The reservation time may be an absolute time or a relative time in relation to a current time, but in the example here a user designates an absolute time as the reservation time 907. On the designation screen 900, it is possible to make a setting, by the menus of reference numerals 901 to 905, for example, for the number of copies, a staple setting, a punch setting, a feed setting, a resolution setting, a print color designation, or the like. In the present embodiment, related menus for finishing 903 and feed 904 are described.

FIG. 9B illustrates a designation screen 910 that the printer driver 403 displays on the image display apparatus 204 for a user to designate a discharge destination. Reference numeral 911 is a list for deciding a discharge destination in the image forming apparatus 111 for a print job. A user can select a desired discharge destination from a pull-down menu. FIG. 9C illustrates a designation screen 920 that the printer driver 403 displays on the image display apparatus 204 for a user to designate a paper feed unit. Reference numeral 921 is a list for deciding a paper feed unit in the image forming apparatus 111 for a print job.

When a user presses an OK button 908 on the designation screen 900, the printer driver 403, in a case where the output method is print, transmits a print job to the image forming apparatus 111 through the LAN 105 via the system spooler 404. Meanwhile, in a case where the output method is print reservation, the printer driver 403 temporarily stores intermediate data via the spooler 405 in the spool file 406, and performs a calculation of the total number of print sheets. In a case where the total number of print sheets of the print job does not exceed the maximum capability of the image forming apparatus 111, the printer driver 403 transmits the print job to the image forming apparatus 111 via the system spooler 404 and the LAN 105. Meanwhile, in a case where the total number of print sheets of the print job exceeds the maximum capability of the image forming apparatus 111, the printer driver 403 displays a warning screen on the image display apparatus 204.

FIG. 10A to FIG. 10C illustrate examples of warning screens that the printer driver 403 displays on the image display apparatus 204. Note that description is given here of examples in which warning screens are displayed on the image display apparatus 204 of the information processing terminal 101 as the method for outputting the warning messages, but the present invention is not intended to be limited thereto. For example, configuration may be taken to output a warning message by audio or vibration, or to output by a combination of these.

FIG. 10A illustrates a warning screen 1000 that is displayed in a case where the total number of print sheets of a print job exceeds the maximum number of contained sheets of a paper feed cassette of the image forming apparatus 111. On the warning screen 1000, buttons 1001 and 1002 are displayed such that they can be selected. When the button 1001 is selected, printing is started as is, and when the button 1002 is selected, printing is canceled.

FIG. 10B illustrates a warning screen 1010 that is displayed in a case where the total number of print sheets of a print job exceeds the maximum number of stacked sheets of a discharge tray of the image forming apparatus 111. On the warning screen 1010, buttons 1011 and 1012 are displayed such that they can be selected. When the button 1011 is selected, printing is started as is, and when the button 1012 is selected, printing is canceled.

FIG. 10C illustrates a warning screen 1020 that is displayed in a case where the total number of print sheets of a print job exceeds the maximum number of contained sheets of a paper feed cassette of the image forming apparatus 111 and the maximum number of stacked sheets of the discharge tray. On the warning screen 1020, buttons 1021 and 1022 are displayed such that they can be selected. When the button 1021 is selected, printing is started as is, and when the button 1022 is selected, printing is canceled.

<Processing for Generating Print Data>

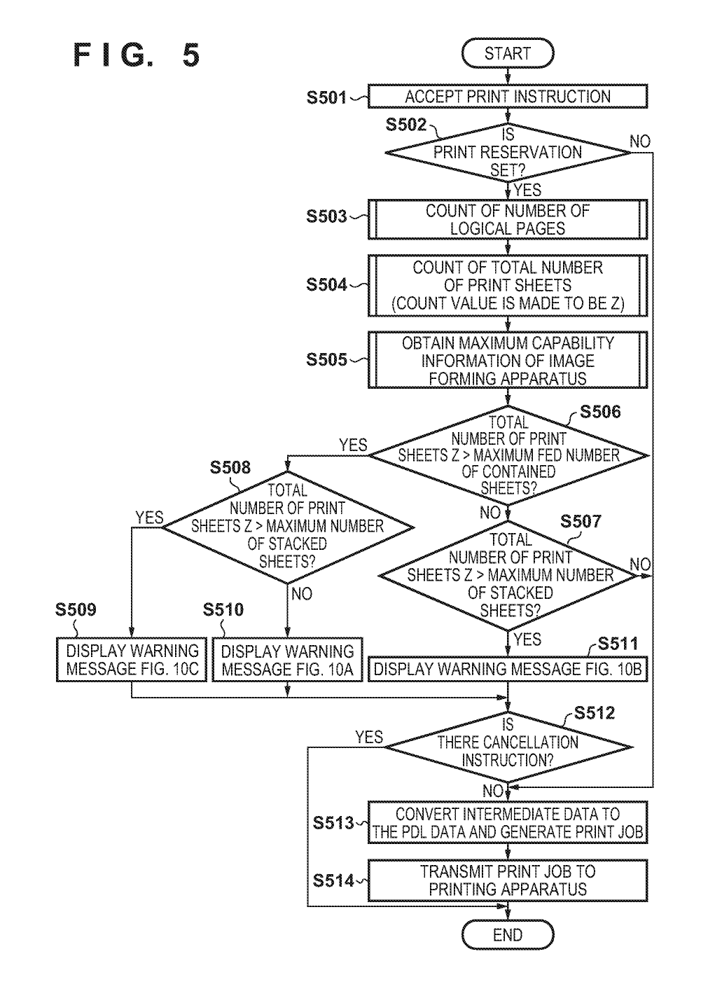

Next, with reference to FIG. 5, a processing procedure of a process for generating print data of the information processing terminal 101 in the present embodiment will be described. The processing described below is realized by, for example, the CPU 201 of the information processing terminal 101 reading a program stored in the auxiliary storage apparatus 203 into the RAM 202 and executing the program.

In step S501, the CPU 201 accepts an instruction to print from a user via the application 401. For example, upon the OK button 908 of the designation screen 900 being pressed, a print job transmitted from the information processing terminal 101 is received. Next, in step S502, the CPU 201 references the output method in the print setting information set on the designation screen 900, and determines whether or not the output method is print reservation. In a case where the output method is print reservation, the processing advances to step S503, and in cases other than print reservation, the processing advances to step S513.

In step S503, the CPU 201 performs a count of the number of logical pages of the print data, and the processing advances to step S504. Details of the method for counting the number of logical pages are described later. In step S504, the CPU 201 performs a count of the total number of print sheets of the print data, and the processing advances to step S505. Details of the method of counting the total number of print sheets are described later. Here, the count value of the total number of print sheets is made to be Z. The total number of print sheets Z is assumed to be something that the printer driver 403 stores in the RAM 202 or the auxiliary storage apparatus 203, and can reference at any time.

In step S505, the CPU 201 obtains the maximum capability information of the image forming apparatus 111, and advances to step S506. Details of the method of obtaining the maximum capability information of the image forming apparatus 111 are described later. Next, in step S506, the CPU 201 performs a comparison to determine whether or not the total number of print sheets Z of the print data exceeds the maximum number of contained sheets of the image forming apparatus 111. In the case where the result of the comparison is that the total number of print sheets Z of the print data exceeds the maximum number of contained sheets of the image forming apparatus 111, the processing advances to step S508, and in the case where the total number of print sheets Z does not exceed the maximum number of contained sheets, the processing advances to step S507.

In step S508, the CPU 201 performs a comparison to determine whether or not the total number of print sheets Z of the print data exceeds the maximum number of stacked sheets of the image forming apparatus, and in the case where the result of the comparison is that the total number of print sheets Z exceeds the maximum number of stacked sheets, the processing advances to step S509, and as illustrated in the warning screen 1020 of FIG. 10C, a warning message is displayed on the image display apparatus 204. Meanwhile, in a case where in step S508 the total number of print sheets Z of the print data does not exceed the maximum number of stacked sheets of the image forming apparatus, the processing advances to step S510, and the CPU 201, as illustrated in the warning screen 1000 of FIG. 10A, displays a warning message on the image display apparatus 204.

Meanwhile, in step S507, the CPU 201, similarly to step S508, performs a comparison to determine whether or not the total number of print sheets Z of the print data exceeds the maximum number of stacked sheets of the image forming apparatus, and in the case where the result of the comparison is that the total number of print sheets Z exceeds the maximum number of stacked sheets, the processing advances to step S511, and in the case where the total number of print sheets Z does not exceed the maximum number of stacked sheets, the processing advances to step S513. In step S511, the CPU 201, as illustrated in the warning screen 1010 of FIG. 10B, displays the warning message on the image display apparatus 204, and the processing advances to step S512.

In step S512, the CPU 201 accepts from the user a press of the button 1001, 1011, or 1021 for “YES” or the button 1002, 1012, or 1022 for “NO” regarding whether or not to continue printing. In a case where a “NO” button press is accepted, a process for generating print data is ended. Meanwhile, in a case where a “YES” button press is accepted, the processing advances to step S513.

In step S513, the CPU 201 converts intermediate data of a print job that is outputted from the application 401 or stored in the spool file 406 into PDL data to thereby generate print data, and then advances to step S514. In step S514, the CPU 201 transmits print data to the image forming apparatus 111 via the system spooler 404, and ends the processing of this flowchart.

<Number of Logical Pages Count Processing>

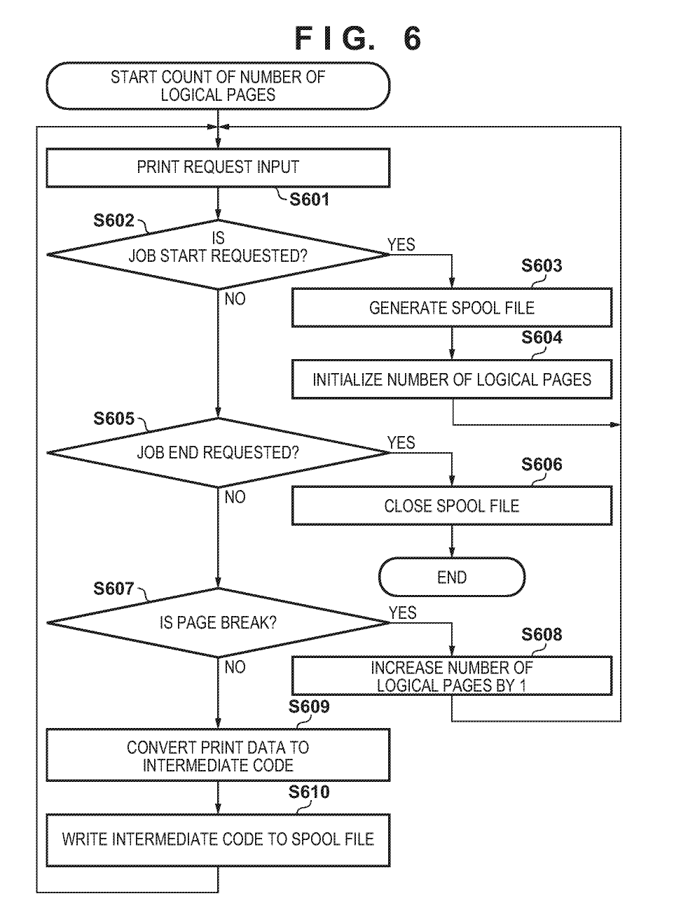

Next, with reference to FIG. 6, details of processing for counting the number of logical pages of step S503 described above in the information processing terminal 101 in the present embodiment will be described. The processing described below is realized by, for example, the CPU 201 of the information processing terminal 101 reading a program stored in the auxiliary storage apparatus 203 into the RAM 202 and executing the program.

In step S601, the printer driver 403 accepts input of a print request via the graphics engine 402 from the application 401. In a case where the printer driver 403 accepts a print request, the printer driver 403 advances to step S602, and determines whether or not the accepted print request is a request to start a print job. In the case of a request to start a print job, the processing advances to step S603. In the case where the print request is not a request to start a print job, the processing advances to step S605.

In step S603, the printer driver 403, via the spooler 405, generates an intermediate data file in the spool file 406, and advances to step S604. In step S604, the printer driver 403 executes an initialization of a counter of the number of logical pages of print data, and returns to step S601. In step S605, the printer driver 403 determines whether or not the accepted print request is a request to end the print job, and in the case of an end request, the processing advances to step S606. In step S606, the printer driver 403 determines that the spooling process of the print job has ended, closes the spool file, and ends the processing of this flowchart.

Meanwhile, in a case where the accepted print request is not an end request in step S605, the processing advances to step S607. In step S607, the printer driver 403 performs a determination as to whether or not the accepted print request is a page break, and in the case of a page break, the processing advances to step S608, and in the case where the print request is not a page break, the processing advances to step S609. In step S608, the printer driver 403 increases the counter of the number of logical pages by one, returns to step S601, and accepts the next print request. Meanwhile, in step S609, the printer driver 403 performs a conversion into intermediate data in order to store the print request in the spool file 406, and the processing advances to step S610. In step S610, the printer driver 403, via the spooler 405, stores the intermediate data in the spool file 406, and returns to step S601.

The foregoing is processing for counting the number of logical pages in the print data. A number of logical pages counter is assumed to be something that the printer driver 403 stores in the RAM 202 or the auxiliary storage apparatus 203, and can reference at any time.

<Processing for Counting Total Number of Print Sheets>

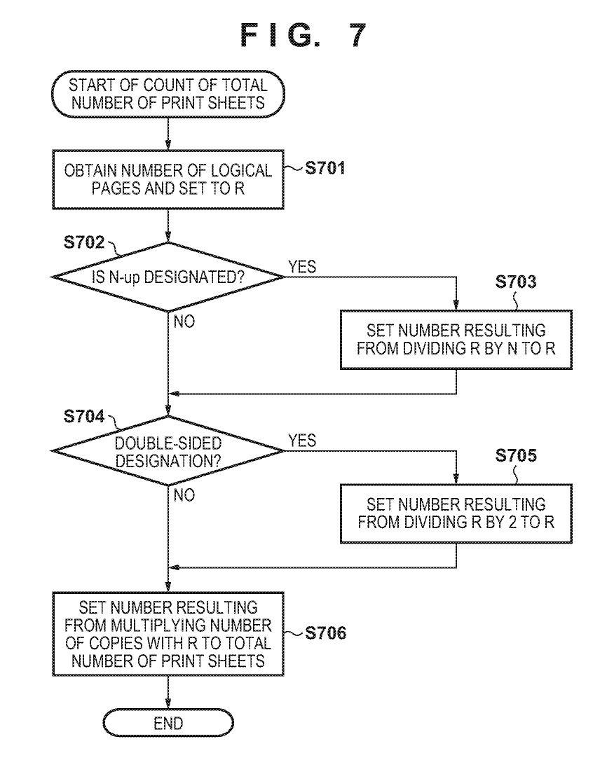

Next, with reference to FIG. 7, details of processing for counting the total number of print sheets of step S504 described above in the information processing terminal 101 in the present embodiment will be described. The processing described below is realized by, for example, the CPU 201 of the information processing terminal 101 reading a program stored in the auxiliary storage apparatus 203 into the RAM 202 and executing the program.

In step S701, the printer driver 403 references the number of logical pages for print data stored in the RAM 202 or the auxiliary storage apparatus 203 and holds that number. The number of logical pages held here is assumed to be R. After step S701, the processing advances to step S702, and the printer driver 403 determines whether or not an N-up setting for collectively printing a plurality of pages on a single sheet is set in the print job settings. In a case where the N-up setting has been made, the processing advances to step S703, and in the case where the N-up setting has not been made, the processing advances to step S704.

In step S703, the printer driver 403 overwrites the number of logical pages R with a number resulting from dividing R by N, and the printer driver 403 holds the result, and advances to step S704. In step S704, the printer driver 403 determines whether or not a double-sided setting has been made in the print job settings, and in the case where a double-sided setting has been made, advances to step S705, and in a case where a double-sided setting has not been made, advances to step S706. In step S705, the printer driver 403 overwrites R with a number resulting from dividing R by 2, and the printer driver 403 holds the result, and advances to step S706.

In step S706, the printer driver 403 multiplies the number of copies set in the print job by R, and makes the result the total number of print sheets of the print job, and stores it in the RAM 202 or the auxiliary storage apparatus 203.

The foregoing is processing for counting the total number of print sheets in the print data. The total number of print sheets is assumed to be something that the printer driver 403 stores in the RAM 202 or the auxiliary storage apparatus 203, and can reference at any time.

<Processing for Obtaining Image Forming Apparatus Capability Information>

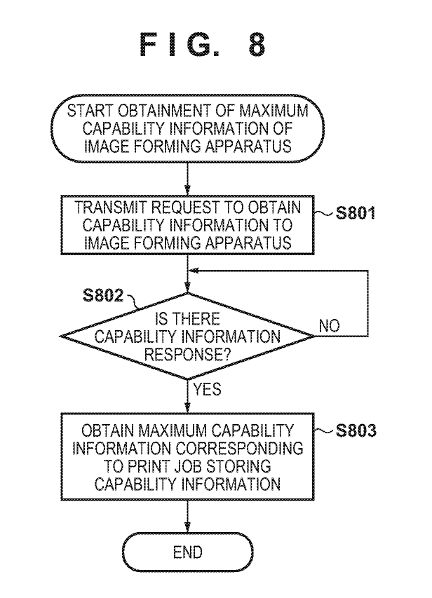

Next, with reference to FIG. 8, details of the processing in the information processing terminal 101 in the present embodiment for obtaining capability information of the step S505 described above will be described. The processing described below is realized by, for example, the CPU 201 of the information processing terminal 101 reading a program stored in the auxiliary storage apparatus 203 into the RAM 202 and executing the program.

In step S801, the printer driver 403, transmits a request to obtain capability information via the LAN 105 to the image forming apparatus 111, and advances the processing to step S802. In step S802, the printer driver 403 determines whether or not a response from the image forming apparatus 111 was received. In a case where a response from the image forming apparatus 111 was received, the processing advances to step S803, and in the case where there is no response, a response is awaited in step S802.

In step S803, the printer driver 403, based on the obtained capability information, obtains the maximum capability information of the image forming apparatus. For example, in the print job setting, the maximum number of contained sheets and the maximum number of stacked sheets are as follows in the case where the print paper size is set to A3 and the paper feed unit is set to automatic, and the discharge tray 2 is set for the discharge destination. For example, in a case where the capability information of the image forming apparatus illustrated in FIG. 11 is used as an example, since the paper feed unit is automatic, the cassette 1, the cassette 2, and the manual feed are targets, but the maximum number of contained sheets is the sum total of the maximum number of contained sheets in cassette 2 and the manual feed which support the print paper size A3. Similarly, for the maximum number of stacked sheets of the discharge tray, the maximum number of stacked sheets is obtained by comparing against the maximum number of stacked sheets for each discharge tray and the discharge destination set in the print job which are indicated in the capability information of the image forming apparatus illustrated in FIG. 11. The maximum capability information corresponding to the obtained print job is assumed to be something that the printer driver 403 stores in the RAM 202 or the auxiliary storage apparatus 203, and can reference at any time.

Also, here, configuration is such that capability information of the image forming apparatus when the print job is executed is obtained. However, the present invention is not limited to this configuration, and for example, configuration may be such that when adding the printer driver 403 to the auxiliary storage apparatus 203, capability information of the corresponding image forming apparatus 111 is obtained, and stored in the RAM 202 or the auxiliary storage apparatus 203 in advance. In such a case, at the time of execution of the print job, it is possible to refer to the stored information without obtaining capability information, and it is possible to perform more high-speed processing.

As described above, the information processing terminal according to the present embodiment accepts a print job inputted into the image forming apparatus via the user operation and obtains capability information of the image forming apparatus. Also, the information processing terminal compares the total number of print sheets for when the accepted print job will be processed and the maximum number of print sheets that the image forming apparatus can process without requiring user action, which is included in the obtained capability information. Furthermore, the information processing terminal, in the case where the result of the comparison is that the total number of print sheets exceeds the maximum number of print sheets, outputs a warning message including that user action will be necessary. In this way, by virtue of the present embodiment, in the case where the total number of print sheets of a print job exceeds the maximum number of contained sheets or the maximum number of stacked sheets of the image forming apparatus, it becomes possible to display a warning message as illustrated in the warning screens 1000, 1010, and 1020. Thus, it is possible to determine whether or not to stop printing during processing of a job based on the processing capabilities of the image forming apparatus and to output a warning message suitable to a user who inputted the job, and thereby the user can know that the print reservation job will stop in the middle of printing. With this, it becomes possible to prevent a print reservation job being started when a user is absent and the print stopping part way through, and the print not being completed.

<Variation>

The present invention is not limited to the foregoing embodiments, and various variations are possible. For example, in the foregoing embodiments, control of whether or not to display a warning message or the like only in the case of a print reservation job is performed, but configuration may be taken to perform the warning even when a normal print job is inputted. Note that configuration may be taken to decide whether or not to perform control as described above even for a normal print job in accordance with a setting by an administrator. In such a case, configuration may be taken to control so as to enable setting on each image forming apparatus.

### Second Embodiment

Below, description will be given for a second embodiment of the present invention. In the above-described first embodiment, a comparison of the total number of print sheets of the print data and the capability information of the image forming apparatus was performed, but in the present embodiment, configuration is such that the image forming apparatus obtains information of already received print reservation jobs, and performs a comparison against the total number of print sheets considering the number of print sheets of the already received print reservation jobs that may affect the print reservation job. The internal configuration and software of the information processing terminal 101 and the configuration of the image forming apparatus 111 are similar to in the foregoing first embodiment, and so description thereof is omitted. In the present embodiment, differences from the foregoing first embodiment are mainly described.

<Print Reservation Job Information>

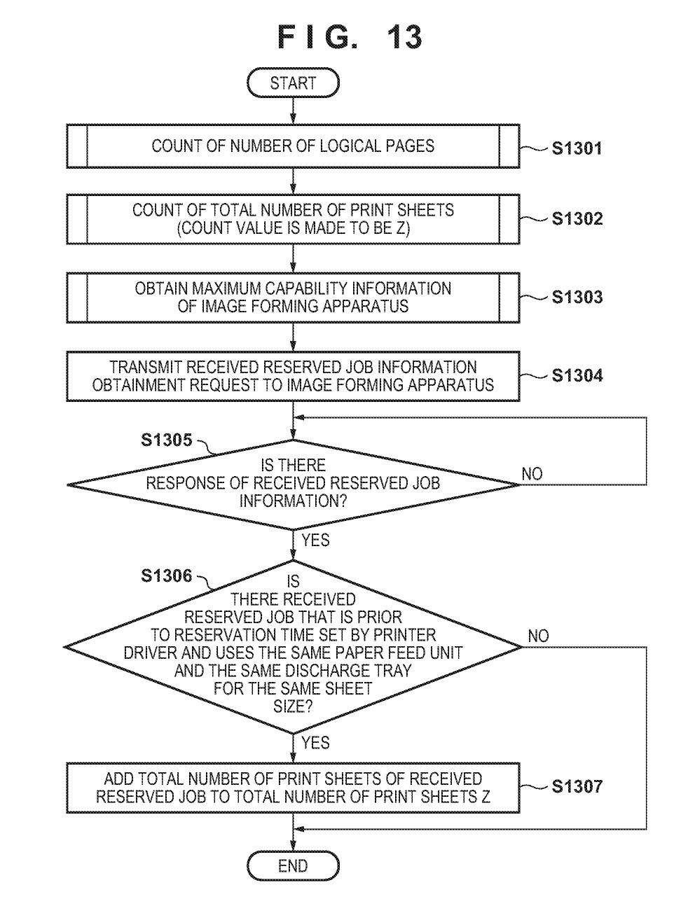

With reference to FIG. 12, print reservation job information according to the present embodiment will be described. The print reservation job information 1200 indicates an example of received print reservation job information that the printer driver 403 obtained from the image forming apparatus 111. The print reservation job information 1200 is information of print jobs that are already reserved in the image forming apparatus 111, and includes information of all jobs that have not been printed yet. In the present embodiment, considering this information, it is determined whether printing will stop during execution of a print job that is being inputted into the image forming apparatus 111 from the information processing terminal 101, and the user is warned.

In the print reservation job information 1200, information of the total number of print sheets, the sheet size, the paper feed unit, the discharge destination, and the reserved time is included for each print reservation job that the image forming apparatus 111 received. For example, in the reserved job “job1”, the total number of print sheets is “100 sheets”, the sheet size is “A4”, and the designated paper feed unit is “cassette 1”, the discharge destination is “tray 1”, and the reserved time is “21:00”. In such a case, if the reserved time of the print job being inputted is later than “21:00”, execution will be after the reserved job “job1”, and therefore it will be necessary to consider the number of print sheets of the reserved job. In other words, for the total number of print sheets, it is necessary to compare the maximum number of contained sheets and the maximum number of stacked sheets adding the total number of print sheets 100 of the reserved job “job1” to the numbers of sheets of the print job to be inputted from the current time. Similarly, for other jobs, consideration is necessary. Note that consideration is not necessary in the case of different paper feed units and discharge destinations.

<Processing for Calculating Total Number of Print Sheets>

Next, with reference to FIG. 13, processing for calculating the total number of print sheets in the present embodiment will be described. The processing described below is realized by, for example, the CPU 201 of the information processing terminal 101 reading a program stored in the auxiliary storage apparatus 203 into the RAM 202 and executing the program.

In step S1301, the printer driver 403 performs processing to count the number of logical pages of the print data, but since this processing is the same as step S503, description thereof is omitted. Next, in step S1302, the printer driver 403 performs processing to count the total number of print sheets of the print data, but since this processing is the same as step S504, description thereof is omitted. Here, the total number of print sheets counted in step S1302 is made to be Z.

Next, in step S1303, the printer driver 403 obtains the maximum capability information of the image forming apparatus, but since this is the same as step S505, description is omitted. Next, in step S1304, the printer driver 403, functioning as a reservation information obtaining unit, transmits a request to obtain print reservation job information that was received to the image forming apparatus 111 via the LAN 105, and advances to step S1305. In step S1305, the printer driver 403 determines whether or not a response of received print reservation job information was received from the image forming apparatus 111. In the case where a response was received, the processing advances to step S1306, and in the case where a response has not been received in step S1305, the processing returns to step S1305 and the response is awaited.

In step S1306, the printer driver 403 determines from the obtained received print reservation job information whether there is a print reservation job that is prior to the reservation time designated in the print data, where the print reservation job uses the same paper feed unit and the same discharge tray for the same sheet size. If so, it is determined that there is an already reserved print job that will have an effect, and the processing advances to step S1307; if not, the processing of this flowchart is ended. In step S1307, the printer driver 403 adds the total number of print sheets of the received print reservation job to the total number of print sheets Z held in step S1302, overwrites Z, and ends the processing of this flowchart. Since the processing to display a warning message using the total number of print sheets Z stored in the processing of this flowchart is the same as the processing from step S506 of FIG. 5, description thereof will be omitted.

As described above, the information processing terminal according to the present embodiment, when a print reservation job is inputted into an image forming apparatus, obtains information of print jobs that were already reserved on the image forming apparatus, and performs a display of a warning message or the like considering the number of print sheets of these print reservation jobs. Accordingly, it is possible to display a warning message in a case where the print data transmitted from the information processing terminal 101 does not exceed the maximum number of contained sheets of the image forming apparatus 111 or the maximum number of stacked sheets of the discharge tray but that will exceed one of them in combination with the already received print reservation jobs.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2018-051522 filed on Mar. 19, 2018, which is hereby incorporated by reference herein in its entirety.

What is claimed is:

1. An information processing terminal operable to input a print job into an image forming apparatus, the terminal comprising:
an acceptance unit that accepts a print job to be inputted into the image forming apparatus via a user operation;
a memory device that stores a set of instructions; and
at least one processor that executes the set of instructions to:
obtain capability information of the image forming apparatus, and
in a case where a total number of print sheets for when the accepted print job will be processed exceeds a maximum number of print sheets that can be processed without the image forming apparatus requiring user action, output a warning message that includes that user action will be required, wherein the maximum number of print sheets is included in the obtained capability information.

2. The information processing terminal according to claim 1, wherein
the at least one processor executes instructions in the memory device to:
in a case where the print job accepted by the acceptance unit is a print reservation for executing printing at a designated time and the total number of print sheets exceeds the maximum number of print sheets, output the warning message.

3. The information processing terminal according to claim 1, wherein
the at least one processor executes instructions in the memory device to:
display, on a display unit of the information processing terminal, a warning screen that selectably includes a display for starting the print job accepted by the acceptance unit and a display for canceling the print job.

4. The information processing terminal according to claim 1, wherein
in the capability information, information of a maximum number of contained sheets and a size of the sheets for each paper feed cassette that the image forming apparatus is provided with and a maximum number of stacked sheets for each discharge tray that the image forming apparatus is provided with is included.

5. The information processing terminal according to claim 4, wherein
in the maximum number of print sheets, the maximum number of contained sheets and the maximum number of stacked sheets are included, and
the at least one processor executes instructions in the memory device to:
in a case where the total number of print sheets exceeds at least one of the maximum number of contained sheets and the maximum number of stacked sheets, the total number of print sheets is determined to exceed the maximum number of print sheets, output the warning message.

6. The information processing terminal according to claim 1, wherein
the at least one processor executes instructions in the memory device to:
obtain from the image forming apparatus reservation information indicating information of an already reserved print job in the image forming apparatus, and
for the obtained reservation information, add, to the total number of print sheets, a number of print sheets in a print job that will affect the print job accepted by the acceptance unit, and then compare the total number of print sheets and the maximum number of print sheets.

7. The information processing terminal according to claim 6, wherein
the print job that will affect the print job accepted by the acceptance unit is a print job for which a reservation time that is prior to the reservation time of the print job accepted by the acceptance unit is designated and for which the same paper feed cassette, the same sheet size, and the same discharge tray are used as the print job accepted by the acceptance unit.

8. The information processing terminal according to claim 1, wherein
the at least one processor executes instructions in the memory device to:
transmit a request for capability information via a network to the image forming apparatus, and receive the capability information from the image forming apparatus as a response to the request.

9. The information processing terminal according to claim 1, further comprising:
a storage unit that, when a printer driver for inputting a print job into the image forming apparatus is installed in the information processing terminal, obtains the capability information from the image forming apparatus and stores the capability information,
wherein the at least one processor executes instructions in the memory device to:
obtain the capability information from the storage unit.

10. A method for controlling an information processing terminal operable to input a print job into an image forming apparatus, the method comprising:
accepting a print job to be inputted into the image forming apparatus via a user operation;
obtaining capability information of the image forming apparatus; and
in a case where a total number of print sheets for when the accepted print job will be processed exceeds a maximum number of print sheets that can be processed without the image forming apparatus requiring user action, outputting a warning message that includes that user action will be required wherein the maximum number of print sheets is included in the obtained capability information.

11. A non-transitory computer-readable storage medium storing a computer program for causing a computer to execute each step in a method for controlling an information processing apparatus operable to input a print job into an image forming apparatus, the method comprising:
accepting a print job to be inputted into the image forming apparatus via a user operation;
obtaining capability information of the image forming apparatus; and
in a case where a total number of print sheets for when the accepted print job will be processed exceeds a maximum number of print sheets that can be processed without the image forming apparatus requiring user action, outputting a warning message that includes that user action will be required wherein the maximum number of print sheets is included in the obtained capability information.

12. An image forming apparatus, comprising:
an acceptance unit that accepts a print job via a user operation;
a memory device that stores a set of instructions; and
at least one processor that executes the set of instructions to:
in a case where a total number of print sheets for when the print job accepted by the acceptance unit will be processed exceeds a maximum number of print sheets that the image forming apparatus can process without requiring user action, output a warning message that includes that user action will be required.
